(19) United States
(12) Patent Application Publication
(10) Pub. No.: US 2006/0262725 A1
(43) Pub. Date: Nov. 23, 2006

(54) Packet filtering

(75) Inventor: Paul Barrett, Ipswich (GB)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: Psytechnics Limited, IPSWICH (GB)

(21) Appl. No.: 11/415,952

(22) Filed: May 2, 2006

(30) Foreign Application Priority Data
May 4, 2005 (GB) 0509079.0

(51) Int. Cl. H04J 1/16; H04L 12/54; H04J 3/14; H04L 12/26

(52) U.S. Cl. 370/235; 370/428

(57) ABSTRACT

This invention relates to a method and apparatus for filtering network packets. The method comprises a method of filtering a packet in a packet switched network in which two complementary packets are transmitted in opposite directions between a particular source and a particular destination comprising the steps of: a) selecting a complementary portion of the source and destination address of said packet; b) performing a commutative operation on said complementary portion; and c) processing or discarding the packet in dependence upon the results of said commutative operation.

### TECHNICAL FIELD

This invention relates to a method and apparatus for filtering network packets. In particular to filtering network packets in order to decide whether a packet is processed by a particular processor.

### BACKGROUND

Signals carried over telecommunications links can undergo considerable transformations, such as digitisation, encryption and modulation. They can also be distorted due to the effects of lossy compression and transmission errors.

Quality monitoring systems are currently under development which can be used to evaluate a systems performance. Passive monitoring systems monitor packets on a transmission path.

A passive monitor monitors packets traveling in both directions between a source and a destination. In a multi processor monitor there is a filter at front of each of the processors to decide which packets are to be monitored.

In known monitoring methods, packets which are sent from a particular source to a particular destination may be processed by a different set of processors than those packets sent between that destination and that source.

In some applications it is desirable to process packets travelling in both directions between a particular destination and a particular source by the same processor.

One such example is where the packets represent a duplex path in a voice (or video) over IP connection and it is desirable to monitor the quality of that connection. It is necessary to monitor both transmissions in order to measure (for example) any echo which is present.

### SUMMARY OF THE INVENTION

In this invention a filtering method is used such that packets which are transmitted between a particular source and a particular destination are processed by the same processor as each other in order to facilitate such monitoring.

According to the invention there is provided a method of filtering a packet in a packet switched network in which two complementary packets are transmitted in opposite directions between a particular source and a particular destination comprising the steps of: a) selecting a pair of complementary portions of the source address and of the destination address of said packet; b) performing a commutative operation on said pair of complementary portions; and c) processing or discarding the packet in dependence upon the results of said commutative operation.

Preferably the method further comprises the steps of d) selecting a further pair of complementary portions of the source address and of the destination address of said packet; e) performing a commutative operation on said further pair of complementary portions; and f) combining the results of step b) and step e); wherein the packet is processed or discarded at step c) in dependence upon the combined result determined at step f).

In a preferred embodiment the combining step f) is carried out using an exclusive or function.

In a preferred embodiment the commutative operation is carried out using an exclusive or function.

Preferably, the complementary portions of the packet comprise the 16 most significant bits in a 32 bit source IP address, the 16 least significant bits in the 32 bit source IP address and a 16 bit UDP source port address, together with the 16 most significant bits in a 32 bit destination IP address, the 16 least significant bits in the 32 bit destination IP address and a 16 bit UDP destination port address.

In a preferred embodiment the packet is processed or discarded at step c) in dependence upon a modulo operation performed upon the result of the commutative operation.

Preferably the modulo operation is performed using a modulo divisor which is a prime number.

### BRIEF DESCRIPTION OF THE DRAWINGS

An embodiment of the invention will now be described, by way of example only, with reference to the accompanying drawings in which:

FIGS. 1a and 1b illustrate a monitor in a packet switched network;

FIG. 2a illustrates a packet;

FIG. 2b illustrates a complementary packet;

FIG. 3 is a flow chart illustrating a method in accordance with the present invention;

FIG. 4 illustrates schematically a packet switched network.

### DETAILED DESCRIPTION

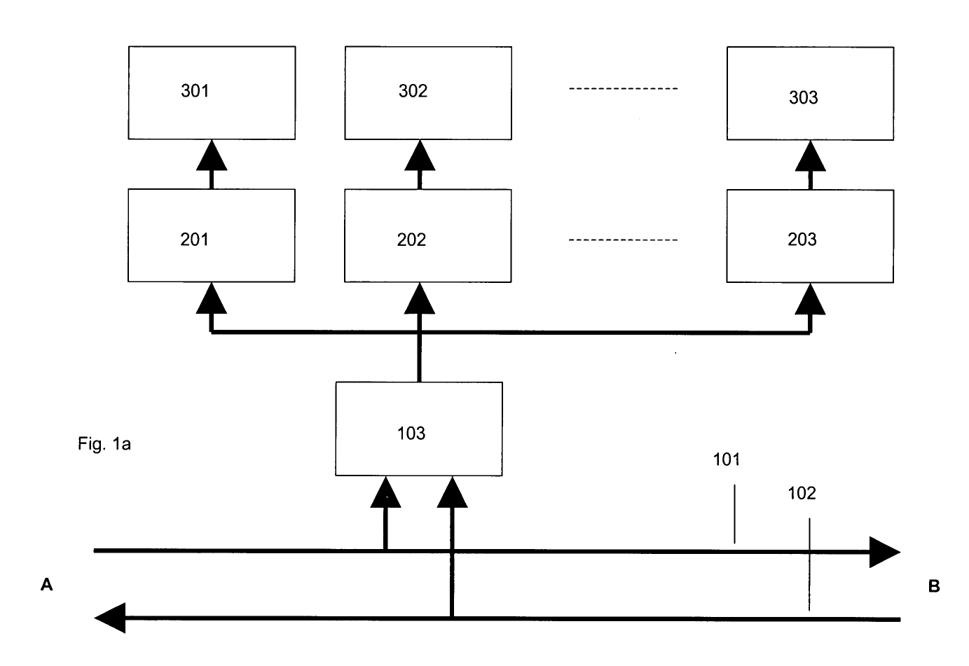

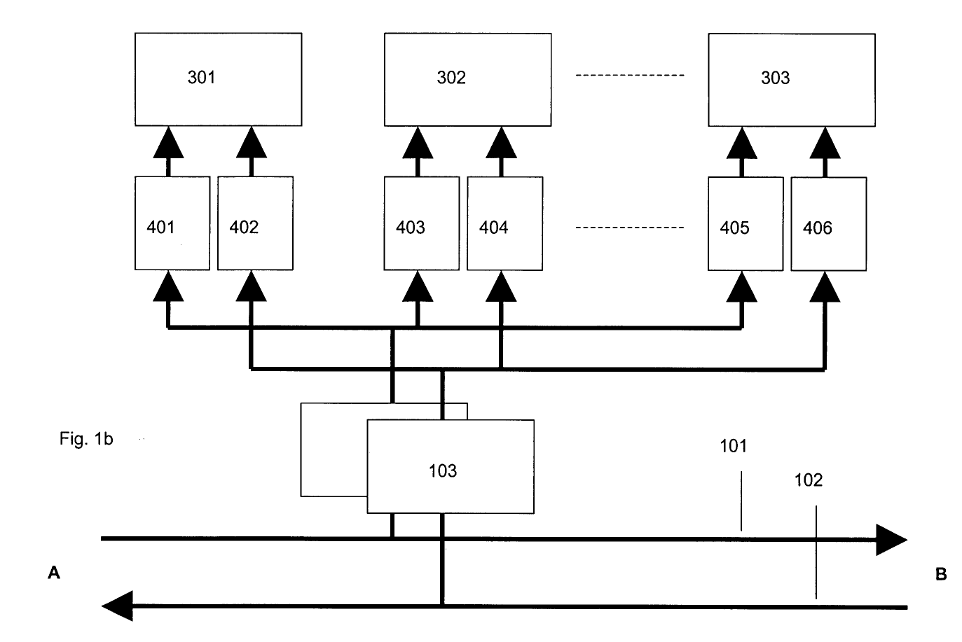

Referring now to FIG. 1a, a transmission link 101 carries packets between a source A and a destination B. A transmission link 102 carries packets between source B and destination A. A monitoring point 103 makes copies of packets travelling on both transmission links 101, 102. Processors 301, 302, 303 each process a subset of the packets copied by the monitoring point 103.

A packet filter 201, 202, 203 is associated with each processor. The packet filter 201 determines which packets are processed by processor 301. The packet filter 202 determines which packets are processed by processor 302. The packet filter 203 determines which packets are processed by processor 303. Alternatively there may be a separate filter for packets travelling on each transmission link. In FIG. 1b packet filters 401, 402 determine which packets are processed by the processor 301. Packet filters 403, 404 determine which packets are processed by the processor 302 and packet filters 405, 406 determine which packets are processed by the processor 303.

In this description the term network refers to any interconnected set of transmission paths, the term packet filter refers to any device which selects which packets to process and which to discard. It will be understood that a filter may be implemented in hardware or in software or a combination of both hardware and software.

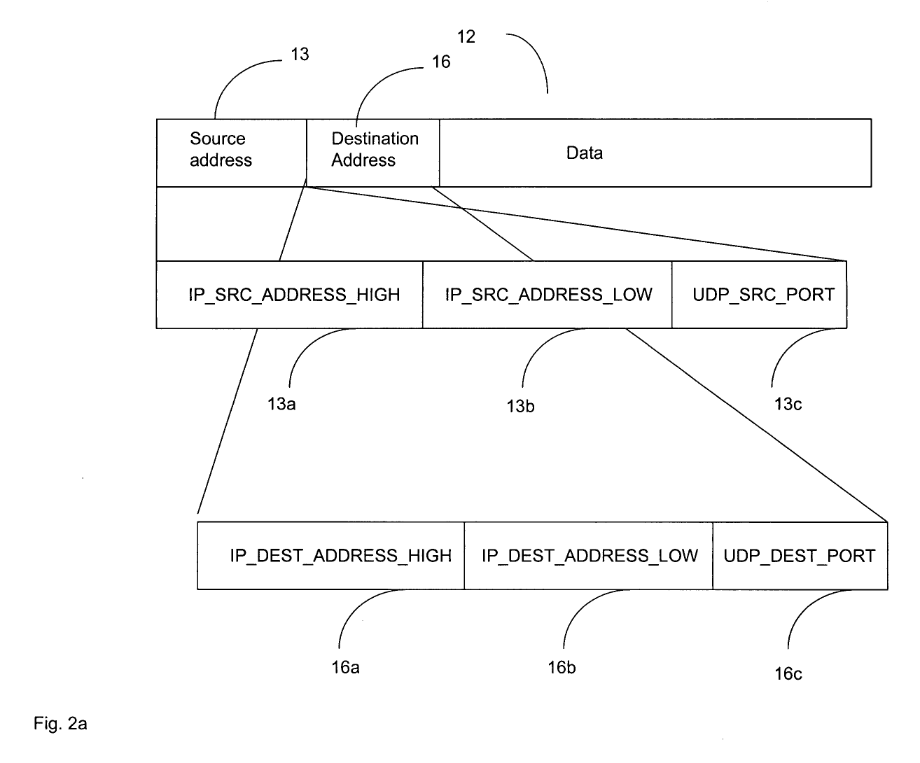

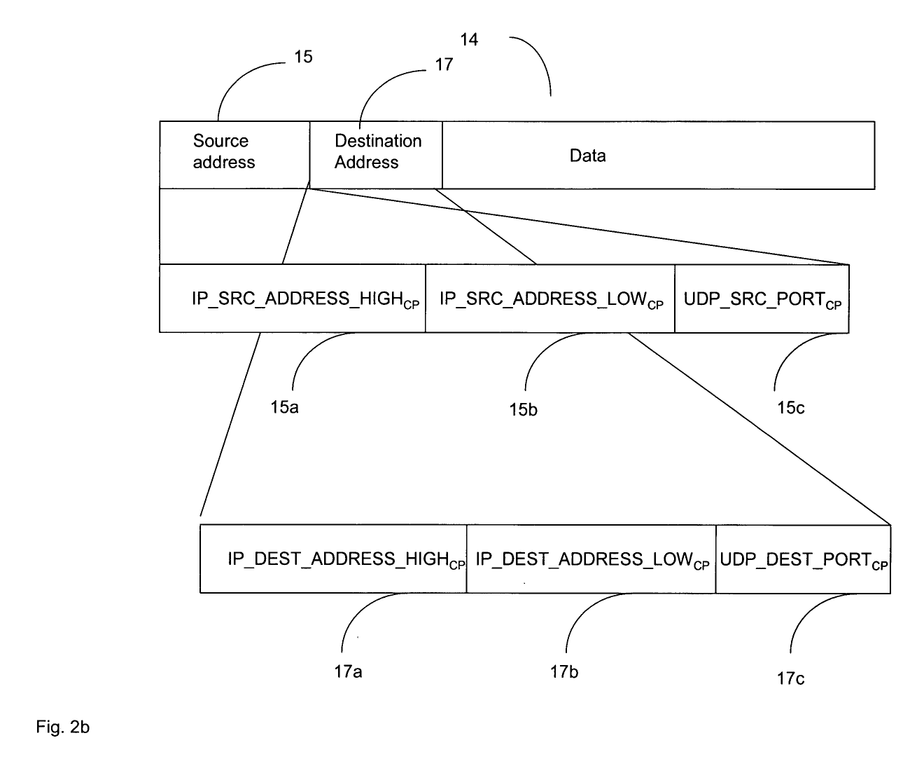

In a packet switched network each packet has a header which contains fields indicating the source and destination of the packet. For example the packet may contain Internet Protocol (IP) addresses and/or User Datagram Port (UDP) addresses. FIG. 2 illustrates an example of such a packet 12.

When two packets represent transmission in opposite direction within the same call in a voice over IP transmission then the source field and the destination field contain complementary portions, such packets will be referred to as complementary packets.

For example, in FIG. 2a if the source address 13 of a packet 12 contains fields IP_SRC_ADDRESS_HIGH 13a IP_SRC_ADDRESS_LOW 13b UDP_SRC_PORT 13c, where IP_SRC_ADDRESS_HIGH 13a represents the 16 most significant bits in a 32 bit IP address and IP_SRC_ADDRESS_LOW 13b represents the 16 least significant bits in the 32 bit IP address and UDP_SRC_PORT 13c represents a 16 bit UDP port address, then the destination address 17 of the complementary packet 14 (FIG. 2b) will contain IP_DEST_ADDRESS_HIGH_{cp} 15a IP_DEST_ADDRESS_LOW_{cp} 15b UDP_DEST_PORT_{cp} 15c

Where

IP_SRC_ADDRESS_HIGH=IP_DEST_ADDRESS_HIGH_{c}
IP_SRC_ADDRESS_LOW=IP_DEST_ADDRESS_LOW_{cp} and
UDP_SRC_PORT=UDP_DEST_PORT_{cp}

A pair of fields comprising the same portion of the source address 13 and destination address 16 within a single packet 12 (eg IP_SRC_ADDRESS_HIGH 13a and IP_DEST_ADDRESS_HIGH 16a) will be referred to as pairs of complementary portions.

In order to filter packets a filter value is calculated using the source address 13 and destination addresses 16 from a packet 12, and then the packet is either processed or discarded in dependence upon this filter value.

For example:

IF filter value<lower threshold OR filter value>upper threshold THEN discard packet.

Known methods of filtering/routing packets may involve performing a hash function on the source and/or destination addresses usually using modulo arithmetic. Such methods do not necessarily allow complementary packets (ie packets representing the same call) to follow the same route as one another.

In the method of the present invention a function is performed on the source and destination addresses in which the part of the function applied to pairs of complementary portions of the packet source and destinations addresses is commutative.

eg using the examples above the filter value may be formed from a combination of
IP_SRC_ADDRESS_HIGH+IP_DEST_ADDRESS_HIGH
IP_SRC_ADDRESS_LOW+IP_DEST_ADDRESS_LOW and
UDP_SRC_PORT+UDP_DEST_PORT
   or
IP_SRC_ADDRESS_HIGH*IP_DEST_ADDRESS_HIGH
IP_SRC_ADDRESS_LOW*IP_DEST_ADDRESS_LOW and
UDP_SRC_PORT*UDP_DEST_PORT
   or
IP_SRC_ADDRESS_HIGHˆIP_DEST_ADDRESS_HIGH
IP_SRC_ADDRESS_LOWˆIP_DEST_ADDRESS_LOW and
UDP_SRC_PORTˆUDP_DEST_PORT
   (where ˆ represents the EXCLUSIVE OR function)

Alternatively different operators may be used for different pairs of complementary portions of the addresses, for example
IP_SRC_ADDRESS_HIGH+IP_DEST_ADDRESS_HIGH
IP_SRC_ADDRESS_LOWˆIP_DEST_ADDRESS_LOW and
UDP_SRC_PORT*UDP_DEST_PORT

The results of these commutative operations may be combined using either commutative or non commutative operators.

The result of such an operation is that the filter value is the same for complementary packets.

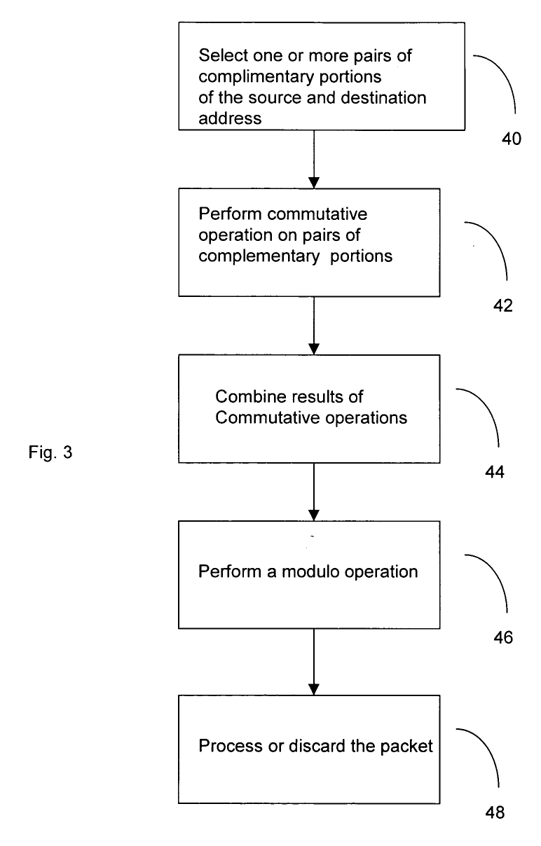

FIG. 3 illustrates the method of the present invention. At step 40 one or more pairs of complementary portions of the source and destination address of the packet are selected. At step 42 a commutative operation is performed on each pair of selected complementary portions. At step 44 the results of the commutative operation(s) are combined to provide a filter value (clearly if a single pair of complementary portions is selected at step 40 then this step is unnecessary).

In order to aid load balancing between processors 301, 302, 303 at step 46 a modulo operation is performed on the filter value and at step 48 the packet is either processed or discarded depending upon the final result.

In a preferred embodiment of the present invention the filter value CHECK1 is calculated as follows:
CHECK1=IP_SRC_ADDRESS_HIGHˆIP_SRC_ADDRESS_LOWˆIP_DEST_ADDRESS_HIGHˆIP_DEST_ADDRESS_LOWˆUDP_SRC_PORTˆUDP_DEST_PORT

ie the commutative operations and the combining operations are all performed using the EXCLUSIVE OR function.

A modulo operation is then applied to CHECK1 (step 48) to form a value CHECK2 that is derived from all of the bits in CHECK1
CHECK2=CHECK1% 251

In the preferred embodiment a prime number is chosen which in this case is 251.

CHECK2 is then compared with an upper and lower limit. If the value of CHECK2 lies between the two limits, the packet is processed, otherwise the packet is discarded, i.e.:
IF (CHECK2<LOWER∥CHECK2>>UPPER) DISCARD PACKET

CHECK2 is treated as an address space and each processor is allocated a subset of this address space. Note that the size of the subset need not be the same for all processors and the whole address space need not be covered, for example, if it is only desired to monitor a proportion of transmission paths. Furthermore if more than one type of monitoring process is desired then some portions of the address space may be selected by more than one filter. If separate filters are provided for packets travelling on different transmission lines, as illustrated in FIG. 1b then the function applied and the upper and lower limit must be the same for each filter associated with a particular processor.

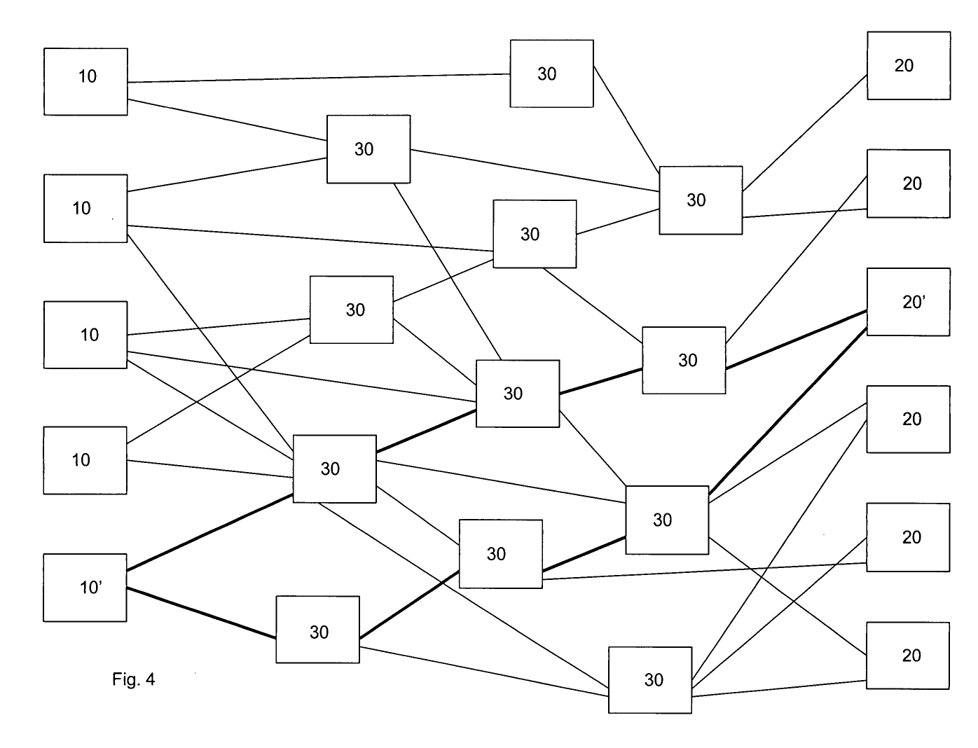

FIG. 4 illustrates schematically a packet switched network connecting a plurality of sources 10 to a plurality of destinations 20 via a plurality of routers 30. It can be seen that there are a plurality of possible paths between a particular source 10′ and destination 20′. For example two such routes are illustrated in bold.

It will be appreciated that the method of packet filtering described may also be used in a routing application to ensure that packets traveling in both directions between a particular source and a particular destination are routed via the same path as each other.

It will be understood by those skilled in the art that the processes described above may be implemented on a conventional programmable computer, and that a computer program encoding instructions for controlling the programmable computer to perform the above methods may be provided on a computer readable medium.

It will also be understood that various alterations, modifications, and/or additions may be introduced into the specific embodiment described above without departing from the scope of the present invention.

1. A method of filtering a packet in a packet switched network in which two complementary packets are transmitted in opposite directions between a particular source and a particular destination comprising the steps of:
a) selecting a pair of complementary portions of the source address and of the destination address of said packet;
b) performing a commutative operation on said pair of complementary portions; and
c) processing or discarding the packet in dependence upon the results of said commutative operation.

2. A method according to claim 1, further comprising the steps of
d) selecting a further pair of complementary portions of the source address and of the destination address of said packet;
e) performing a commutative operation on said further pair of complementary portions; and
f) combining the results of step b) and step e); wherein the packet is processed or discarded at step c) in dependence upon the combined result determined at step f).

3. A method according to claim 2 in which the combining step f) is carried out using an exclusive or function.

4. A method according to claim 1, in which the commutative operation is carried out using an exclusive or function.

5. A method according to claim 1, in which the complementary portions of the packet comprise the 16 most significant bits in a 32 bit source IP address, the 16 least significant bits in the 32 bit source IP address and a 16 bit UDP source port address, together with the 16 most significant bits in a 32 bit destination IP address, the 16 least significant bits in the 32 bit destination IP address and a 16 bit UDP destination port address.

6. A method according to claim 1, wherein the packet is processed or discarded at step c) in dependence upon a modulo operation performed upon the result of the commutative operation.

7. A method according to claim 6 in which the modulo operation is performed using a modulo divisor which is a prime number.

8. A method according to claim 6 in which the modulo operation is performed using the number 251.

9. A packet monitor using a plurality of processors to monitor packets, in which packets to be processed by each processor are selected using a method according to claim 1.

10. A method of routing packets in a packet switched network, in which the next router to which a packet is directed is selected using a method according to claim 1.

11. A computer readable medium carrying a computer program for implementing the method according to claim 1.

12. A computer program for implementing the method according to claim 1.
